(19) United States
(12) Patent Application Publication
(10) Pub. No.: US 2025/0086463 A1
(43) Pub. Date: Mar. 13, 2025

(54) Artificially Intelligent Uncertainty Quantification for Estimates of Evolution Model Parameters

(71) Applicant: MACSO Technologies Limited, Auckland (NZ)

(72) Inventors: Hwan Goh, Auckland (NZ); Saba Samiei, Auckland (NZ); Vincent Russell, Auckland (NZ); Hanxiao Zhang, Auckland (NZ); Philippe Rivard, Carlsbad, CA (US)

(73) Assignee: MACSO Technologies Limited, Auckland (NZ)

(21) Appl. No.: 18/885,359

(22) Filed: Sep. 13, 2024

Related U.S. Application Data
(60) Provisional application No. 63/582,473, filed on Sep. 13, 2023.
(60) Provisional application No. 63/582,471, filed on Sep. 13, 2023.

(51) Int. Cl. G06N 3/086

(52) U.S. Cl. CPC G06N 3/086

(57) ABSTRACT

In some embodiments of the invention, a method for estimating parameters of an evolution model includes identifying an evolution model; obtaining a set of training data values, where each value in the set is associated with a parameter-of-interest (PoI) associated with the evolution model; obtaining a noise model representing noise affecting the output of the evolution model; obtaining a prior model that represents prior information on characteristics of the parameter-of-interest; constructing a loss function for a neural network, where the loss function incorporates the set of training data values, the evolution model, the noise model, and the prior model; and training the neural network with the loss function to obtain updated weights.

### CROSS-REFERENCE TO RELATED APPLICATIONS

The current application claims priority to U.S. Provisional Application No. 63/582,473 entitled “UNCERTAINTY AWARE TRAINING METHOD FOR ARTIFICIALLY INTELLIGENT NOISE FILTER,” filed Sep. 13, 2023, and to U.S. Provisional Application No. 63/582,471 entitled “ARTIFICIALLY INTELLIGENT UNCERTAINTY QUANTIFICATION FOR ESTIMATES OF EVOLUTION MODEL PARAMETERS,” filed Sep. 13, 2023, the disclosures of which are incorporated herein by reference.

### FIELD OF THE INVENTION

The present invention relates generally to statistical inference of real-world data and more specifically to estimating parameters of an evolution model using neural networks.

### BACKGROUND OF THE INVENTION

In order to obtain insights into real-world sequential data, the task is often to prescribe a descriptive parameterized evolution model and estimate the parameters-of-interest (PoI) using the data. Uncertainty quantification (UQ), in turn, provides insight into the accuracy of the parameter estimate. Traditional models for the uncertainty of parameter estimates are often crafted using the prescribed evolution model.

### SUMMARY OF THE INVENTION

In some embodiments of the invention, a method for estimating parameters of an evolution model includes identifying an evolution model; obtaining a set of training data values, where each value in the set is associated with a parameter-of-interest (PoI) associated with the evolution model; obtaining a noise model representing noise affecting the output of the evolution model; obtaining a prior model that represents prior information on characteristics of the parameter-of-interest; constructing a loss function for a neural network, where the loss function incorporates the set of training data values, the evolution model, the noise model, and the prior model; and training the neural network with the loss function to obtain updated weights.

In additional embodiments of the invention, the loss function is

$${W}^{⋆} = {arg min}_{W} \frac{1}{M} {\sum }_{m = 1}^{M} \frac{1 - α}{α} ( log \vert {Γ}_{p o s t}^{k , ( m )} \vert + ‖ {μ}_{p o s t}^{k , ( m )} - {u}^{k , ( m )} {‖}_{{( {Γ}_{p o s t}^{k , ( m )} )}^{- 1}}^{2} ) + \frac{1}{p} {\sum }_{p = 1}^{p} ‖ {y}^{n , ( m )} - ℱ ( {u}_{draw}^{k , ( m )} ( W ) , t ) - {μ}_{v}^{n , ( m )} {‖}_{{( {Γ}_{v}^{n , ( m )} )}^{- 1}}^{2} + tr ( {( {Γ}_{pr}^{k , ( m )} )}^{- 1} {Γ}_{p o s t}^{k , ( m )} ) + ‖ {μ}_{p o s t}^{k , ( m )} - {μ}_{pr}^{k , ( m )} {‖}_{{( {Γ}_{p r}^{k ( m )} )}^{- 1}}^{2} - log \vert {Γ}_{p o s t}^{k , ( m )} \vert where ( {μ}_{p o s t}^{k , ( m )} , {( {Γ}_{p o s t}^{k , ( m )} )}^{\frac{1}{2}} ) = Ψ ( {y}^{n , ( m )} , W ) , {u}_{draw}^{k , ( m ) , p} ( W ) ∼ N ( {μ}_{p o s t}^{k , ( m )} , {Γ}_{p o s t}^{k , ( m )} )$$

In further embodiments of the invention, the neural network is a recurrent neural network.

In some embodiments of the invention, inputting an observed sequence of data into the trained neural network to obtain statistics of a posterior model.

In several embodiments of the invention, the statistics of a posterior model include mean and covariance of a Gaussian distribution.

In still further embodiments of the invention, the identified evolution model utilizes a log-spectral amplitude expressed as:

$${k}_{⋆}^{} = {\underbrace{{g}_{MMSE , k} {e}^{\frac{1}{2} {\int }_{{v}_{k}}^{∞} \frac{{e}^{- t}}{t} dt}}}_{{g}_{LSA} ( k )} {k}_{}$$

where g_{MMSE,k} represents PoI.

In yet more embodiments of the invention, the identified evolution model utilizes an optimally modified log-spectral amplitude expressed as:

$${k}_{⋆}^{} = {\underbrace{{g}_{min}^{1 - {p}_{k}} {g}_{LSA , k}^{{p}_{k}}}}_{{g}_{OMLSA} ( k )} {k}_{} .$$

Still more embodiments of the invention include inputting a noisy signal short-time spectral amplitude (STSA) to the neural network; and obtaining as output an estimate of minimum mean squared estimate spectral gain.

In still further embodiments, the noise model is expressed as \tilde{y}ₜ˜ [symbol] (ηxₜ, ηxₜ).

### BRIEF DESCRIPTION OF THE DRAWINGS

FIG. 1 conceptually illustrates an AIUQ loss function in accordance with embodiments of the invention.

FIG. 2 is a flow chart illustrating a process for training a neural network to produce parameter estimates from sequential data and an evolution model in accordance with embodiments of the invention.

FIG. 3 conceptually illustrates a process for using a trained neural network to produce parameter estimates from sequential data and an evolution model in accordance with embodiments of the invention.

FIGS. 4A and 4B are graphs illustrating sample distribution of α and β for an example in accordance with an embodiment of the invention.

FIGS. 5A, 5B, 5C, and 5D are graphs illustrating results of an AIUQ trained neural network in accordance with an embodiment of the invention.

FIGS. 6A, 6B, 6C, and 6D are graphs illustrating results of an AIUQ trained neural network in accordance with another embodiment of the invention.

FIGS. 7A, 7B, 7C, and 7D are graphs illustrating results of an AIUQ trained neural network in accordance with another embodiment of the invention.

FIG. 8 illustrates an estimation device in accordance with some embodiments of the invention.

### DETAILED DISCLOSURE OF THE INVENTION

The advent of machine learning has brought upon a paradigm shift where the information contained in datasets are employed to augment traditional evolution models for the uncertainty of parameter estimates. Sequential neural networks in accordance with embodiments of the invention can take in a set of sequential data of any length and an evolution model as input, then yield estimates of parameters-of-interest (PoI) and an accompanying uncertainty quantification (UQ) of the estimates. Both these quantities of PoI and UQ may be informed by the dataset as well as the evolution model and a model of prior information. This can be achieved during the training process of a neural network by incorporating the dataset and evolution model into the loss function so that the information they contain can be embedded into the neural network weights. In some embodiments of the invention, the sequential data is a time dependent series.

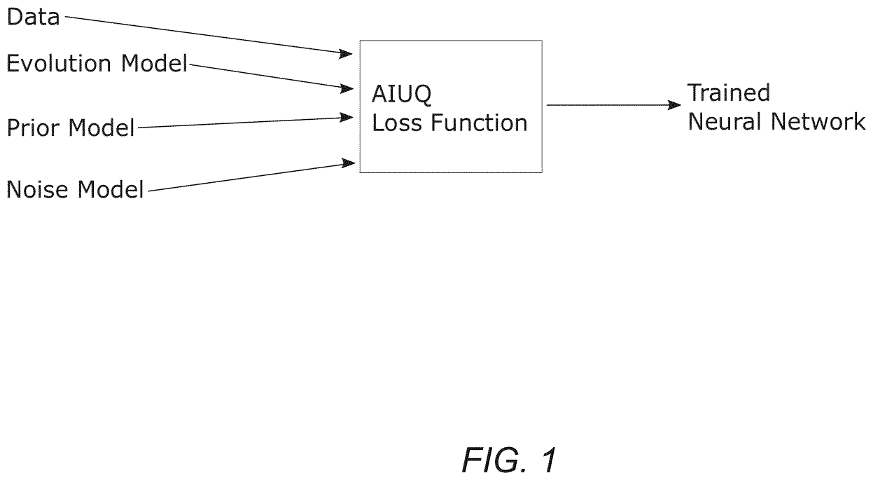

Training a sequential neural network in many embodiments of the invention utilizes a loss function that facilitates the training of variable-length sequential neural networks using datasets that include variable-length sequential data. This loss function is motivated by the Bayesian paradigm of uncertainty quantification (UQ). A characteristic of the Bayesian framework is that it allows the leverage of prior information to perform UQ. Therefore, along with the dataset and prescribed evolution model, the inclusion of a prior model in the loss function ensures that the sequential neural network is also exposed to prior information. A schematic of a loss function in accordance with embodiments of the invention is conceptually illustrated in FIG. 1.

Some embodiments provide a method of training a neural network that can determine an estimate of a parameter of interest (PoI) and an indication of uncertainty quantification (UQ) for the estimate of the PoI. In several embodiments the neural network is provided a training dataset of sequential data, with data of the dataset paired with PoI in accordance with an evolution model. In some embodiments a loss function represents a distance between the PoI in accordance with the evolution model and an output of the neural network. In some embodiments the loss function includes components a) indicative of signal noise in input of the neural network, b) indicative of a difference between a noisy signal and a result of application of a parameter of interest to the evolution model, and/or c) indicative of distance between outputs of the neural network and prior knowledge of the outputs quantified as a statistical distribution. In several embodiments results of evaluation of the loss function are used in modifying weights of the neural network.

In some embodiments the method includes inputting an observed dataset of sequential data to a trained neural network, data of the sequential data paired with PoI in accordance with an evolution model, with outputs of the neural network including estimates of the PoI and UQ for the estimates of the PoI. In several embodiments results of evaluation of a loss function, such as described above, are used in modifying weights of the neural network to train it.

In many embodiments, the neural network is housed or provided by a computer architecture. In some embodiments the computer architecture is a server-based architecture, while in other embodiments the computer architecture is a microcontroller. In some embodiments the process is performed by one or more processors configured by program instructions. In some embodiments the process is performed by circuitry of an application specific circuit (ASIC). In some embodiments the neural network is used in conjunction with or as part of a control system, with the control system modulating control based, in part, on UQ estimated or determined by the neural network.

The discussions here utilize the following notation:

Let [symbol] : [symbol] ^{k}× [symbol] ^{h}→ [symbol] ⁿ denote a prescribed evolution model that maps from the parameter space [symbol] ^{k} to the space of sequential data [symbol] ⁿ. Additionally, [symbol] ^{h} refers to the space of indexing quantities.

Let yⁿ=[y₁, y₂, . . . , yₙ]^{T}∈ [symbol] ⁿ denote a sequence of length n where yₜ∈ [symbol] denotes a point in the sequence.

Let u^{k}=[u₁, u₂, . . . , uₖ]^{T}∈ [symbol] ^{k} denote a PoI of the prescribed evolution model where uₜ∈ [symbol] denotes a real-valued parameter-of-interest.

Let {y^{n,(m)}, u^{k,(m)}}ₘ₌₀^{M} denote a dataset of sequential data paired with their associated PoI. Note that k, n∈ [symbol] are not necessarily fixed; the dataset can contain sequences of varying lengths with each sequence paired with PoI of varying number of parameters. In processes such as those discussed further below, this may be used as a training dataset.

Let Ψ denote a sequential neural network and W its weights.

Let μ and Γ denote mean and covariance respectively of a Gaussian distribution [symbol] (μ, Γ).

Let μₚₒₛₜ^{k} and Γₚₒₛₜ^{k} denote the posterior mean and posterior covariance which are the outputs of the sequential neural network. In the field of UQ, the posterior mean is often considered to be the PoI estimate and the posterior covariance is the quantified uncertainty of the estimate.

Let [symbol] (μᵥ^{n,(m)}, (Γᵥ^{n,(m)})⁻¹) and [symbol] (μₚᵣ^{k,(m)}, (Γₚᵣ^{k,(m)})⁻¹) denote the respective noise and prior model associated with the pair (y^{n,(m)}, u^{k,(m)}) of the dataset.

Let α denote a tunable parameter.

The loss function for training a sequential neural network in accordance with several embodiments of the invention is as follows:

$${W}^{⋆} = {arg min}_{W} \frac{1}{M} {\sum }_{m = 1}^{M} \frac{1 - α}{α} ( log \vert {Γ}_{p o s t}^{k , ( m )} \vert + ‖ {μ}_{p o s t}^{k , ( m )} - {u}^{k , ( m )} {‖}_{{( {Γ}_{p o s t}^{k , ( m )} )}^{- 1}}^{2} ) \qquad ( 1 )$$

$$+ \frac{1}{p} {\sum }_{p = 1}^{p} ‖ {y}^{n , ( m )} - ℱ ( {u}_{draw}^{k , ( m )} ( W ) , t ) - {μ}_{v}^{n , ( m )} {‖}_{{( {Γ}_{v}^{n , ( m )} )}^{- 1}}^{2} \qquad ( 2 )$$

$$+ tr ( {( {Γ}_{pr}^{k , ( m )} )}^{- 1} {Γ}_{p o s t}^{k , ( m )} ) + ‖ {μ}_{p o s t}^{k , ( m )} - {μ}_{pr}^{k , ( m )} {‖}_{{( {Γ}_{p r}^{k ( m )} )}^{- 1}}^{2} - log \vert {Γ}_{p o s t}^{k , ( m )} \vert \qquad ( 3 )$$

$$where$$

$$( {μ}_{p o s t}^{k , ( m )} , {( {Γ}_{p o s t}^{k , ( m )} )}^{\frac{1}{2}} ) = Ψ ( {y}^{n , ( m )} , W ) , \qquad ( 4 )$$

$${u}_{draw}^{k , ( m ) , p} ( W ) ∼ N ( {μ}_{p o s t}^{k , ( m )} , {Γ}_{p o s t}^{k , ( m )} ) \qquad ( 5 )$$

Now suppose some sequential data y_{obs}ⁿ is observed. The posterior model p(u^{k}|y_{obs}ⁿ)= [symbol] (μₚₒₛₜ^{k}, Γₚₒₛₜ^{k}) of the PoI of the prescribed evolution model can be formed using the trained sequential neural network. Specifically, this involves modeling the statistics μₚₒₛₜ^{k}, Γₚₒₛₜ^{k} of the posterior model which, in turn, can be considered as forming an estimate μₚₒₛₜ^{k} of the PoI and quantifying the uncertainty with Γₚₒₛₜ^{k}. In some embodiments, the posterior model can be considered to be a truncated Gaussian distribution for cases where the space of possible values for PoI is bounded.

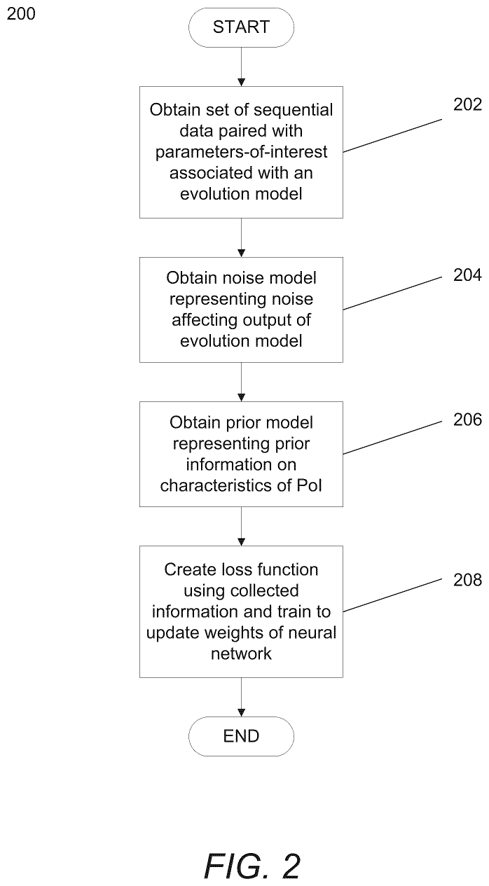

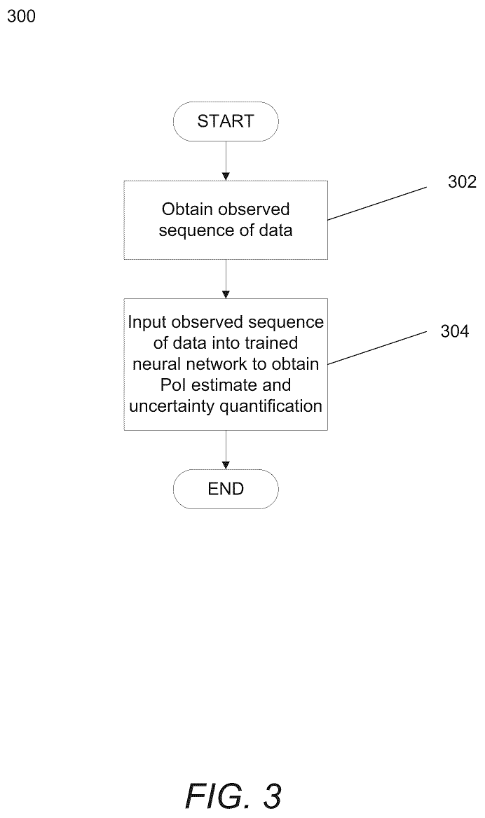

Many embodiments of the invention include training a neural network that can determine an estimate of a parameter of interest (PoI) and an indication of uncertainty quantification (UQ) for the estimate of the PoI, which may utilize noise and prior models and a loss function as discussed above. In several embodiments, the training can be thought of as an offline phase (i.e., which may be performed in advance and/or where the result is not expected in real-time). A process for training a neural network in accordance with embodiments of the invention is illustrated in FIG. 2.

The process 200 includes selecting or creating an evolution model and obtaining (202) a set of data paired with PoI associated with the evolution model. In several embodiments of the invention, this includes collecting M instances of sequential data y^{n,(m)} paired with PoI u^{k,(m)} associated via the prescribed evolution model [symbol] . Together, these form the training dataset {y^{n,(m)}, u^{k,(m)}}ₘ₌₀^{M} to be used for training a sequential network. Any of a number of methods may be used to construct this dataset. For example, experiments or simulation studies can be performed that represent the action of the prescribed evolution model [symbol] on selected PoI values u^{k,(m)} in order to obtain corresponding sequential data y^{n,(m)}.

The process includes constructing (204) a noise model [symbol] (μᵥ^{n,(m)}, Γᵥ^{n,(m)}) representing noise afflicting the output of the prescribed evolution model to yield observed sequential data.

The process includes constructing (206) a prior model [symbol] (μₚᵣ^{k,(m)}, Γₚᵣ^{k,(m)}) that quantitatively represents any prior information on the characteristics of the PoI.

The process includes selecting a sequential neural network architecture Ψ. This could be, for example, a recurrent neural network (RNN), long short-term memory network (LSTM) or transformer.

The process includes constructing (208) a loss function including the set of training data values, the evolution model, the noise model, and/or the prior model, and optimizing the neural network weights W by training the neural network using the loss function. In several embodiments of the invention, the loss function includes the components (1), (2), and (3) discussed further above.

Given a trained neural network, uncertainty quantification (UQ) can be performed by inputting an observed sequence of data into the trained sequential neural network to obtain the statistics of the posterior model. That is:

$$( {μ}_{post}^{k} , {Γ}_{p o s t}^{k} ) = Ψ ( {y}_{obs}^{n} , {W}^{⋆} ) \qquad ( 6 )$$

with W* the trained weights resulting from the optimization problem (3). Although a specific process is discussed above, one skilled in the art will recognize that variations may be utilized in accordance with embodiments of the invention as appropriate to a particular application. Descriptions of techniques for forming noise models and prior models that may be utilized in accordance with embodiments of the invention can be found in “Solving Bayesian Inverse Problems via Variational Autoencoders” by Goh et al.,

### Examples

Consider the following example where:

The prescribed evolution model is [symbol] : [symbol] ³× [symbol] ⁿ→ [symbol] ⁿ such that [symbol] (α, β, t)=αe^{-βt} where t=[t₁, t₂, . . . , tₙ].

The PoI is of fixed length k=2 where u²=[α, β]^{T}. The superscript k=2 will henceforth be omitted for brevity.

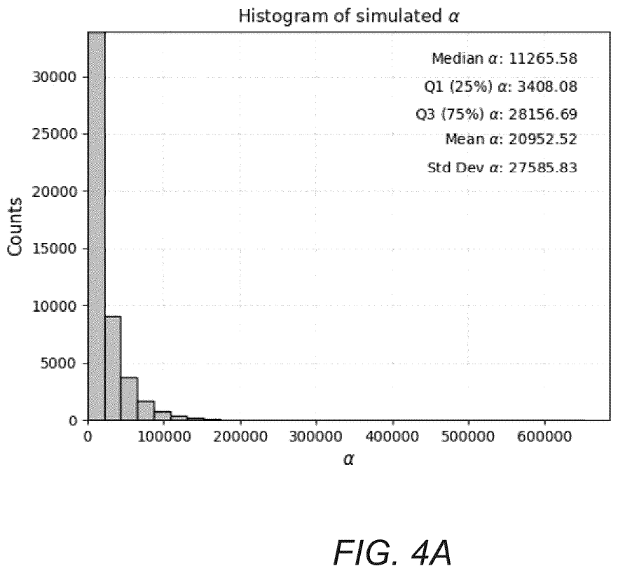

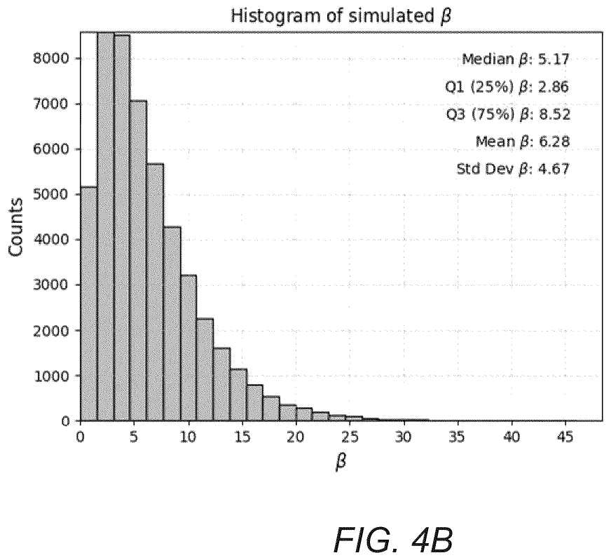

The dataset consists of M=50000 samples {u^{(m)}}ₘ₌₁⁵⁰⁰⁰⁰, the distributions which are illustrated in the histograms shown in FIGS. 4A and 4B.

The corresponding paired values {y^{n,(m)},u^{(m)}}ₘ₌₁⁵⁰⁰⁰⁰ are obtained by mapping {u^{(m)}}ₘ₌₁⁵⁰⁰⁰⁰ through the prescribed evolution model [symbol] .

The noise model [symbol] (μᵥ^{n,(m)},Γᵥ^{n,(m)}) arises from a Gaussian approximation to the Poisson distribution which, in turn, represents a multiplicative noise assumption.

The prior model [symbol] (μₚᵣ^{k,(m)},Γₚᵣ^{k,(m)}) is constructed from fixed values that are selected to represent the dataset distribution displayed in FIGS. 4A and 4B.

A neural network is trained by optimizing (3) with the above components. UQ is performed on three examples of sequential data. In each example, the uncertainty estimates are displayed using

$${μ}_{p o s t , j} \pm 2 {σ}_{re1 , j} \qquad ( 7 )$$

with j∈{1,2} where j=1 corresponds to α and j=2 corresponds to β. Here, σ_{rel,j} refers to the relative standard deviation:

$${σ}_{re1 , j} = \vert \frac{{Γ}_{post , ( j , j )}^{\frac{1}{2}}}{{μ}_{p ost , j}} \vert \times 100. \qquad ( 8 )$$

### Case 1

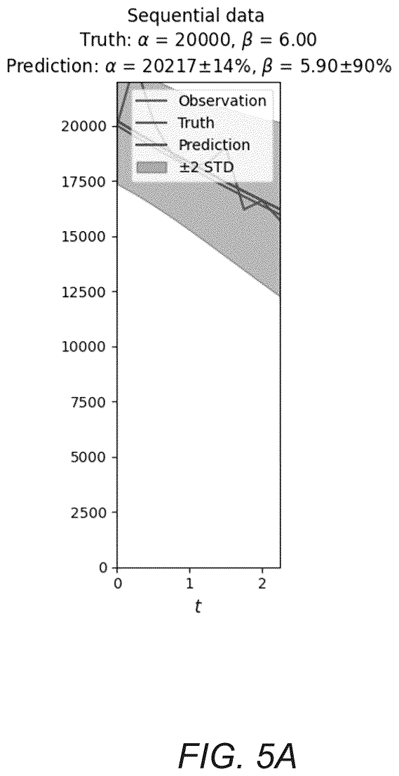

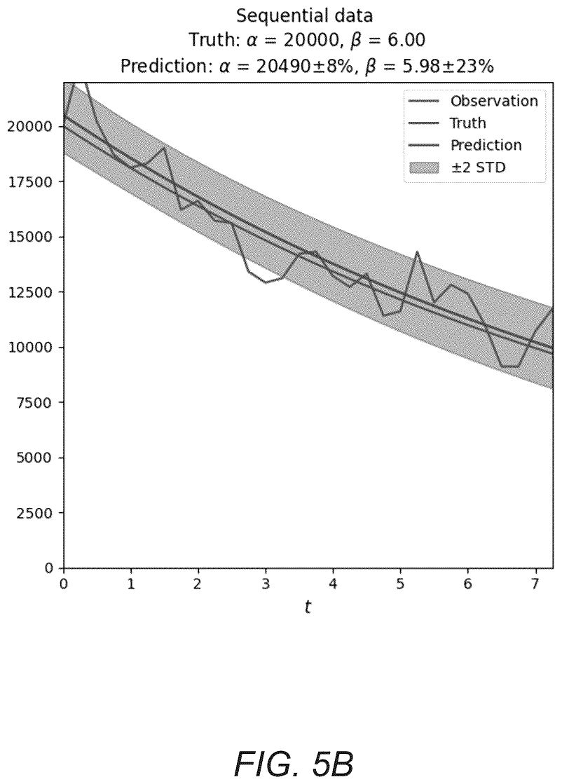

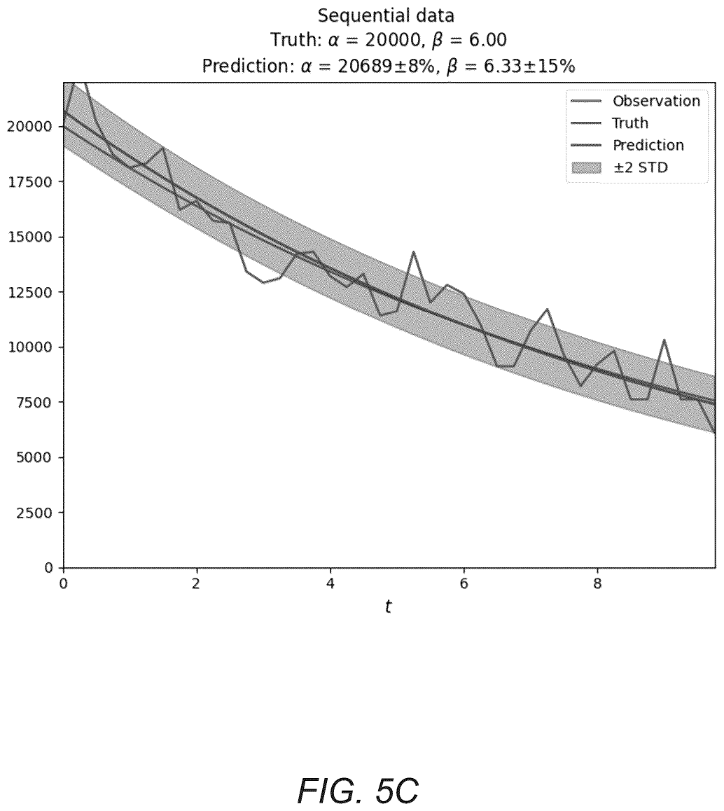

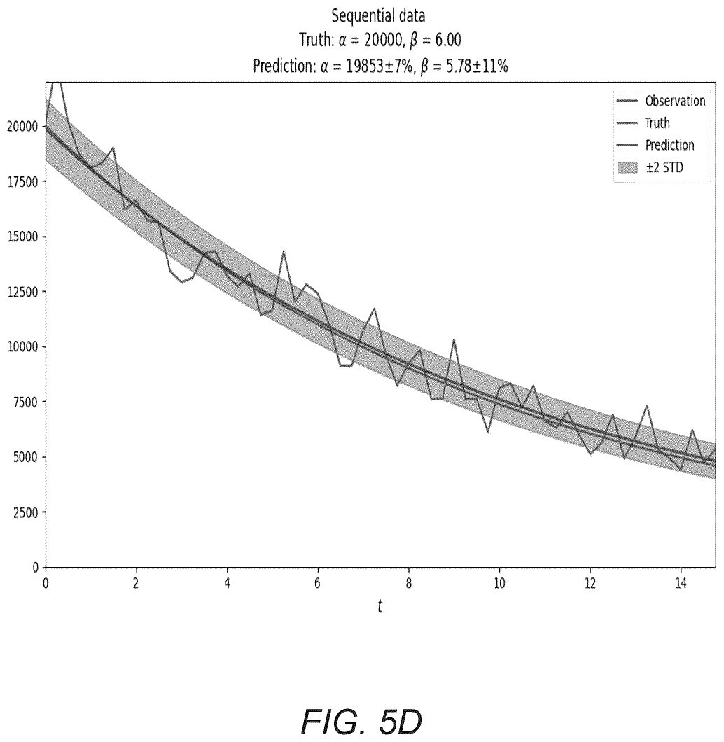

The first sequential data represents an expected case where y_{obs}(t)=20000e^{-6t}. Here, both α=20000 and β=6 lie within the dataset distribution displayed in FIGS. 4A and 4B. The results are displayed in FIGS. 5A to 5D. For the expected sequential data here, as the sequence length increases, the uncertainty of the PoI estimates decreases. Specifically, from 90% to 11%. This makes intuitive sense as longer sequence lengths contain more information.

### Case 2

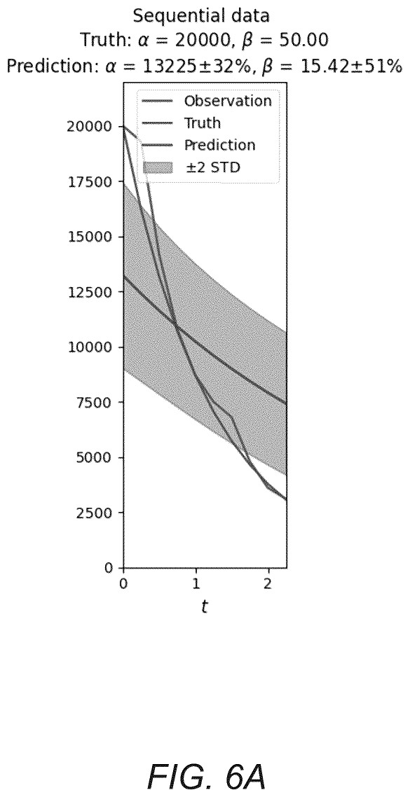

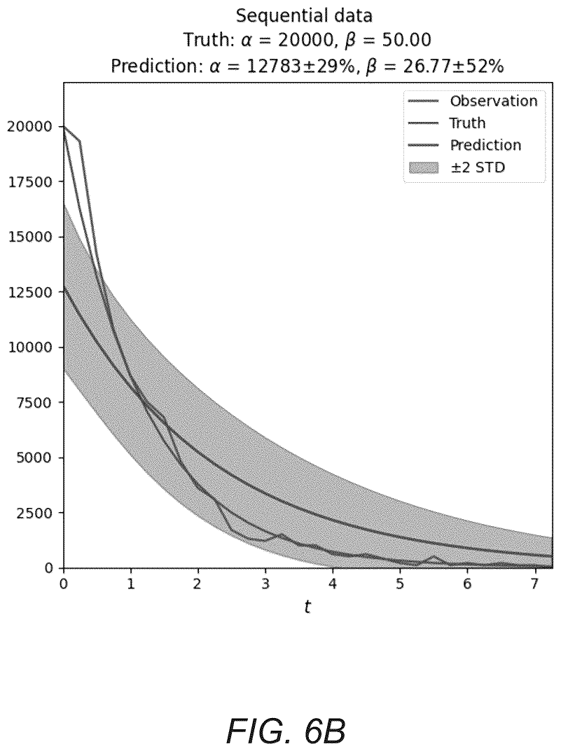

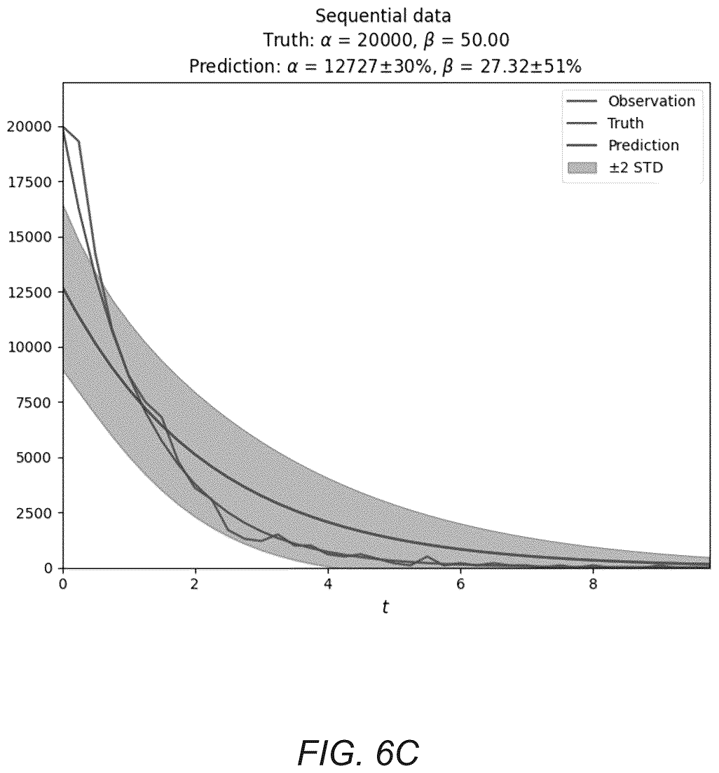

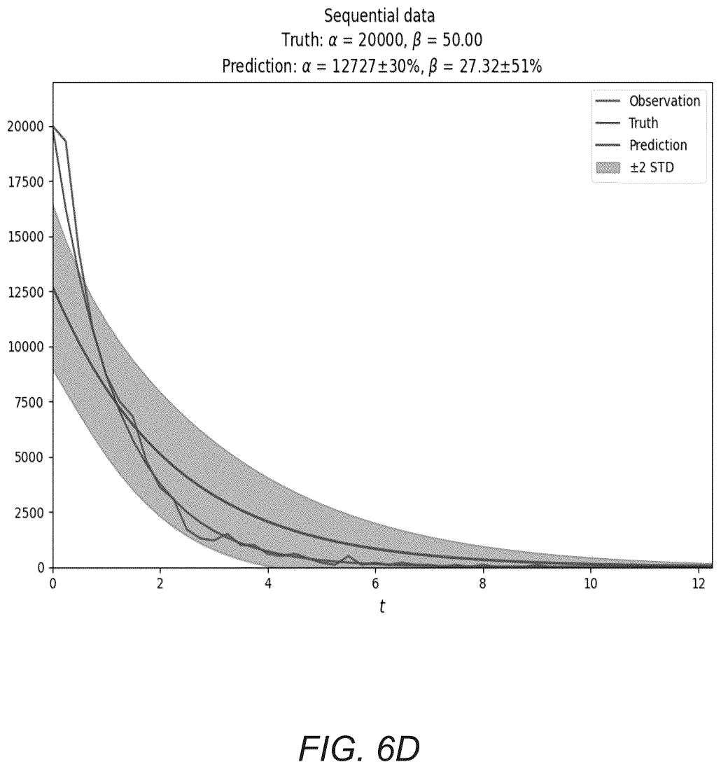

The second sequential data represents an outlier case where y_{obs}(t)=20000e^{-50t}. Here, β=50 lies outside the dataset distribution displayed in FIGS. 4A and 4B. The results are displayed in FIGS. 6A to 6D. The uncertainty of PoI estimates for the outlier sequential data here are larger than that of the expected sequential data. Specifically, it stays around 51% regardless of sequence length. This makes intuitive sense as the sequential neural network is ‘unsure’ of its estimates for cases that lie outside the cases it was exposed to during training.

### Case 3

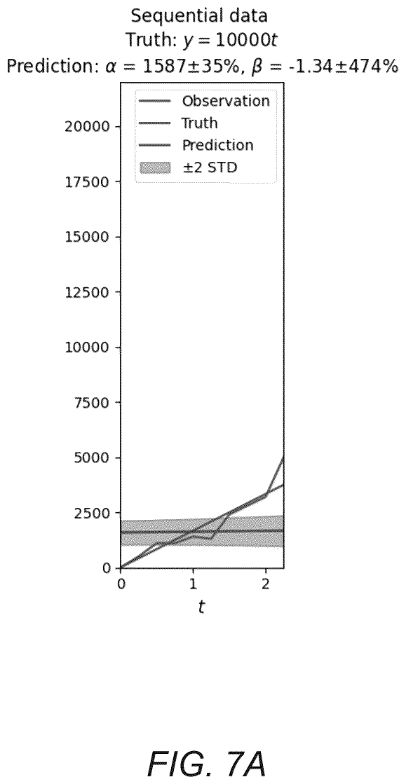

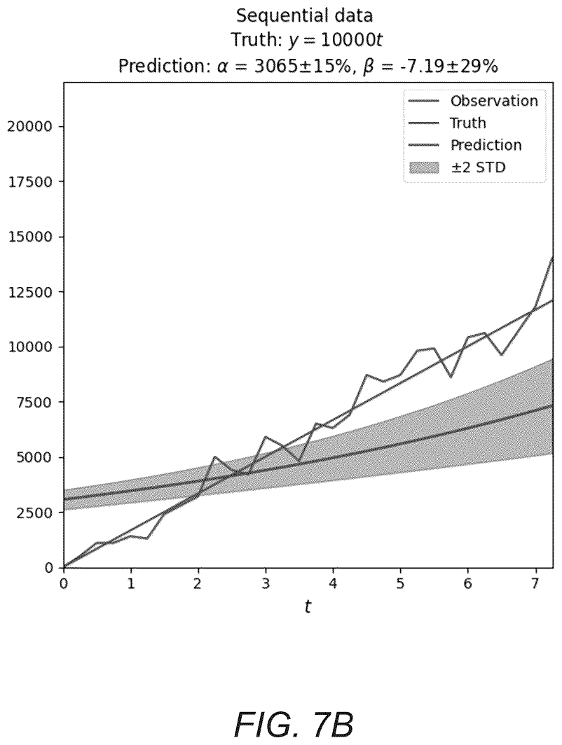

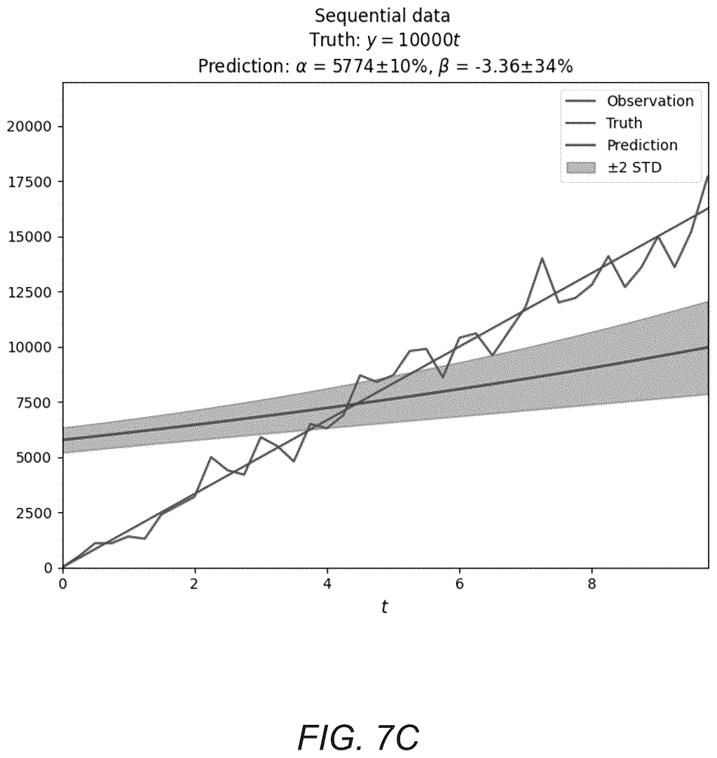

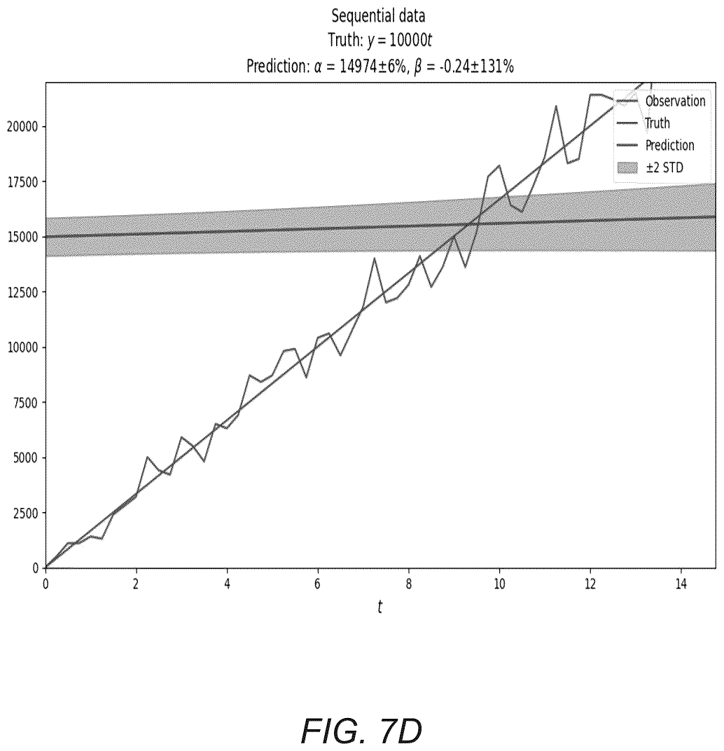

The third sequential data represents a case where the prescribed model is ‘incorrect’ as it is not the correct underlying model of the observed sequential data. That is y_{obs}(t)=10000t which is a linear function and not an exponential. The results are displayed in FIGS. 7A to 7D. For the ‘incorrectly modelled’ sequential data here, the uncertainty in general is larger than that of the other two cases and, for some sequence lengths, severely larger, i.e., 474% and 131% even at maximum sequence length.

### Applications

### Noise Filtration

Signal denoising is a prevalent challenge in various industrial applications. As such, there are many approaches to removing noise. One approach is to frame denoising as an optimization problem that works to obtain filter coefficients which can be used construct enhanced signals from observed noisy signals. Additionally, this optimization problem can be tailored to target specific components of observed noisy signals in order to obtain filters coefficients that can recover components used to construct the enhanced signal.

One such component is the short-time spectral amplitude (STSA) of the short-time fourier transform (STFT) of a time-dependent signal. The key departure of spectral amplitude estimation from other Fourier based signal processing techniques is the assumption that the phase distortion can be ignored. Therefore, after performing the Fourier transform on a noisy signal, the complex values are decoupled into their amplitude and phase. From here, the amplitudes of the clean signal are estimated from the amplitudes of the noisy signal and the phase is later re-introduced before an inverse Fourier transform is applied to reconstruct the signal.

A main short-coming of traditional spectral estimation methods is the non-linear processing distortions caused by the random variations of the noise spectrum. Specifically, the non-linear mapping of the negative or small-valued spectral estimates. Bayesian spectral amplitude estimation methods in accordance with embodiments of the invention offer substantial performance improvements on spectral subtraction by utilizing the probability density functions of the signal and noise process.

Bayesian spectral amplitude estimation may be translated into a loss function that is used to train an artificially intelligent noise filter in accordance with several embodiments of the invention.

Let ŷ(k), ŝ(k), \hat{v}(k) denote the random variable representation of the kth spectral coefficient of the noisy signal, clean signal and noise respectively. Apply the short-time Fourier transform (STFT) to obtain ŷₗ(k), ŝₗ(k), \hat{v}ₗ(k) where k denotes the frequency index of the discrete Fourier transform (DFT) and l denotes the frame index. With this, ŷₗ(k) is referred to as the kth STFT coefficient of the signal for the Ith frame. Assuming the additive noise model, in the STFT domain this becomes:

$${\hat{y}}_{l} ( k ) = {\hat{s}}_{l} ( k ) + {\hat{v}}_{l} ( k ) . \qquad ( 9 )$$

However, as most of this theory can be discussed within a context of a specific frame the subscript l may be omitted. Also, since the DFT is used which produces a finite vector of frequencies, the kth frequency can be denoted with the subscript k to represent the entry of a vector instead of the argument (k).

In the Bayesian estimation approach for signal denoising, the value of the clean signal spectrum ŝ is estimated as a function of the noisy signal spectrum ŷ. To this end, define a distance metric or loss function J between the clean signal ŷ and its estimator \hat{f} and endeavour to minimize the expectation of this distance:

$${𝔼}_{{\hat{s}}_{k} {\hat{y}}_{k}} [ J ( {\hat{s}}_{k} , {\hat{f}}_{k} ) ] = \int \int J ( {\hat{s}}_{k} , {\hat{f}}_{k} ) {p}_{{\hat{s}}_{k} {\hat{y}}_{k}} ) d {\hat{s}}_{k} d {\hat{y}}_{k} \qquad ( 10 )$$

where p_{ŝ}_{ₖ}_{ŷ}_{ₖ} is the joint probability density function (PDF) of ŝ and ŷ. For brevity, the subscripts of the probability density henceforth are omitted as it can be deduced from its arguments. The subscripts of the expectation operator are also omitted when no clarity is lost. With use of Bayes' Theorem, (10) can be rewritten as:

$${𝔼}_{{\hat{s}}_{k} {\hat{y}}_{k}} [ J ( {\hat{s}}_{k} , {\hat{f}}_{k} ) ] = \int ( \int J ( {\hat{s}}_{k} , {\hat{f}}_{k} ) p ( {\hat{s}}_{k} \vert {\hat{y}}_{k} ) ) d {\hat{s}}_{k} ) p ( {\hat{y}}_{k} ) d {\hat{y}}_{k} \qquad ( 11 )$$

In some embodiments, it may be more useful to instead consider the logarithmic distance between the noisy and clean signals. For example, when the signal is an audio signal and the application involves human speech recognition, since the human ear perceives volume in a logarithmic manner, consider the metric function

$$J ( {k}_{} , {k}_{} ) = {( log ( {k}_{} ) - log ( {k}_{} ) )}^{2} . \qquad ( 12 )$$

Now in order to obtain a closed form, Gaussian assumptions can be employed. Specifically, assume that all random vectors are circular symmetric complex Gaussian vectors. Denote the spectral amplitudes of the noisy signal, clean signal, filtered signal and noise as [symbol] respectively so that:

$${\hat{y}}_{k} = {k}_{} {e}^{i {θ}_{{\hat{y}}_{k}}} \qquad ( 13 )$$

$${\hat{s}}_{k} = {k}_{} {e}^{i {θ}_{{\hat{s}}_{k}}} \qquad ( 14 )$$

$${\hat{f}}_{k} = {k}_{} {e}^{i {θ}_{{\hat{f}}_{k}}} \qquad ( 15 )$$

$${\hat{v}}_{k} = {k}_{} {e}^{i {θ}_{{\hat{v}}_{k} .}} \qquad ( 16 )$$

The conditional mean of this is the log-spectral amplitude (LSA):

$${k}_{⋆}^{} = {y}_{k} \frac{{g}_{M M S E ,} {e}^{\frac{1}{2} {\int }_{v}^{∞} \frac{{e}^{- t}}{t} dt}}{{g}_{LSA} ( k )} , {k}_{} \qquad ( 17 )$$

$$where$$

$${v}_{k} = \frac{{ξ}_{k}}{1 + {ξ}_{k}} {γ}_{k} \qquad ( 18 )$$

$${ξ}_{k} = \frac{{σ}_{{\hat{s}}_{k}}^{2}}{{σ}_{{\hat{v}}_{k}}^{2}} \qquad ( 19 )$$

$${γ}_{k} = \frac{{k}_{2}^{}}{{σ}_{{\hat{v}}_{k}}^{2}} . \qquad ( 20 )$$

An extension of this is the optimally modified log-spectral amplitude (OMLSA) which involves the following modification:

$${k}_{*}^{} = {\underbrace{{g}_{min}^{1 - {p}_{k}} {g}_{LSA , k}^{{p}_{k}}}}_{{g}_{OMLSA} ( k )} {k}_{} . \qquad ( 21 )$$

where pₖ∈[0,1] is the speech presence probability and the value gₘᵢₙ∈(0, ∞) represents the lowest boundary threshold.

A term underlying (17) and (21) is the minimum mean squared estimate spectral gain:

$${g}_{MMSE , k} = \frac{{ξ}_{k}}{{ξ}_{k} + 1} . \qquad ( 22 )$$

Indeed, it can be shown that γₖ, vₖ and pₖ can be approximated with respect to g_{MMSE}:

$${γ}_{k} \approx \frac{1}{1 - {g}_{MMSE , k}} \qquad ( 23 )$$

$${ν}_{k} \approx \frac{{g}_{MMSE , k}}{1 - {g}_{MMSE , k}} \qquad ( 24 )$$

$${p}_{k} \approx {g}_{MMSE , k} . \qquad ( 25 )$$

With this in mind, estimates of the g_{MMSE} may be formed from noisy signal STSA [symbol] ₖ which can, in turn, be used to construct enhanced signals. Most traditional estimation methods are entirely model driven. However, utilizing machine learning, the information contained in datasets can be employed in estimation techniques. The advantage of this is that more ‘personalized’ filters can be crafted that target specific applications. Accordingly, a neural network can be trained that takes in the noisy signal STSA [symbol] ₖ as input to yield an estimation of the corresponding g_{MMSE,k}.

Applying the neural network training discussed further above, the STSA of audio signals can be considered the sequential data. The evolution model [symbol] could be the LSA (17) or the OMLSA (21). The parameter-of-interest u=g_{MMSE}. Noise model can be the sample statistics of the STSA of audio signals representing background noise. the prior model can be the sample statistics of the parameter-of-interest.

In additional embodiments of the invention, more modifications may be applied. For example, in some embodiments, a truncated Gaussian distribution is used in place of (5) to accommodate for the parameter-of-interest being bound in (0,1).

### Aerosols

Aerosol physics can be incorporated into the AIUQ loss function in order to better perform uncertainty quantification for aerosol related use-cases. Specifically, aerosol measurement systems that employ particle counts naturally follow a Poisson distribution. In turn, Poisson distributions can be approximated by Gaussian solutions in the cases where particle counts reach sufficiently large values. Specifically, denoting aerosol particle counts by y and x the true particle quantities, observations yₜ∈ [symbol] can be computed by

$${y}_{t} = \frac{{\tilde{y}}_{t}}{η} \qquad ( 26 )$$

where \tilde{y}ₜ is drawn by

$${\tilde{y}}_{t} ∼ Poisson ( {ηx}_{t} ) . \qquad ( 27 )$$

Here, the hyperparameter η>0 to simulate the noise in the data. Specifically, higher values of η represents lower values of noise. With this, the Gaussian approximation to the Poisson distribution is given by:

$${\tilde{y}}_{t} ∼ 𝒩 ( η {x}_{t} , η {x}_{t} ) \qquad ( 28 )$$

which can be used as the noise model of the AIUQ loss function in some embodiments of the invention. Thus, an AIUQ trained neural network can be made aware of the governing aerosol physics. The remaining components, such as the evolution model and the parameter-of-interest, may depend on the application at hand.

### Control Systems

At the most basic level, control systems involve feedback loops which are tasked with perpetually forming estimates of the quantity of interest and then performing some action based on the estimate. The appeal of control systems lies in the automation of reactive tasks. The issue here is that, by design, control systems are required to act on estimates even if the estimates are performed on outlier events. It would therefore be beneficial to employ an outlier detection strategy to ensure that the reactive task is only performed, or only performed to its fullest extent, in response to ideal situations. Otherwise, feedback loops can be irrecoverably disturbed from a desired equilibrium state of operation. A common quantity used to inform outlier detection mechanisms is UQ. The UQ method discussed herein can perform UQ using information from both data and models.

### Computationally Constrained Operations

In most cases, UQ is a computationally demanding task. Broadly speaking, there are two main categories of UQ methods: sampling and optimization. Sampling methods are often inaccurate for large dimensional problems and so often only have efficacy for small problems with a restricted number of Pols. In contrast, although optimization methods preserve accuracy for scenarios with a large number of Pols, they generally require gradient computation which can be expensive. Additionally, both methods are usually iterative and therefore potentially time-consuming and computationally expensive.

For the UQ approach here, although the optimization of the loss function (3) may be time-consuming, this can represent an offline phase. The goal is to provide components to (3) that are descriptive enough to train a neural network capable of performing desirably in all reasonable variations of the scenario it is to operate in. Achieving this, estimation and UQ (which represents the online phase) generally only requires only the propagation of the observed sequential data through the trained neural network. Since this is essentially a series of linear algebraic operations, the propagation through a neural network is mostly unrivalled in speed and computational cost. Thus, with these methods, estimation and UQ on devices as small as microcontrollers may be performed in some embodiments; therefore introducing UQ to internet-of-things related applications. Computational efficiency can be furthered by compressing neural networks via quantization of the weights. Quantization of weights refers to a process of reducing the precision of the weights in a neural network (e.g., from 32-bit floating-point to 8-bit integers) to decrease memory usage and computation while maintaining acceptable model accuracy.

### Estimation Devices

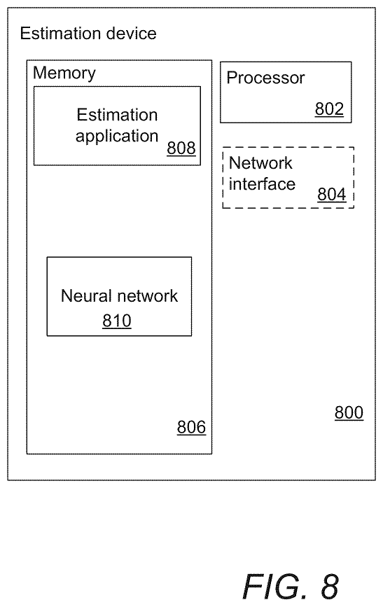

FIG. 8 is a block diagram of an estimation device 800 in accordance with several embodiments of the invention. The estimation device 800 may be a computing device. Estimation device 800 includes a processor 802 and memory 806 that includes an estimation application 808 and neural network 810. The estimation device 800 may also include a network interface 804 that it can use to send and receive information. Although a specific architecture is discussed above, one skilled in the art will recognize that any of a variety of device configurations may be utilized in accordance with embodiments of the invention as appropriate to a particular application.

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed is:

1. A method for estimating parameters of an evolution model, the method comprising:
identifying an evolution model;
obtaining a set of training data values, where each value in the set is associated with a parameter-of-interest (PoI) associated with the evolution model;
obtaining a noise model representing noise affecting the output of the evolution model;
obtaining a prior model that represents prior information on characteristics of the parameter-of-interest;
constructing a loss function for a neural network, where the loss function incorporates the set of training data values, the evolution model, the noise model, and the prior model; and
training the neural network with the loss function to obtain updated weights.

2. The method of claim 1, where the loss function is
$${W}^{⋆} = arg {min}_{W} \frac{1}{M} {\sum }_{m = 1}^{M} \frac{1 - α}{α} ( log \vert {Γ}_{p o s t}^{k , ( m )} \vert + {‖ {μ}_{p o s t}^{k , ( m )} - {u}^{k , ( m )} ‖}_{{( {Γ}_{p o s t}^{k , ( m )} )}^{- 1}}^{2} ) + \frac{1}{p} {\sum }_{p = 1}^{p} {‖ {y}^{n , ( m )} - ℱ ( {u}_{draw}^{k , ( m ) , p} ( W ) , t ) - {μ}_{v}^{n , ( m )} ‖}_{{( {Γ}_{v}^{n , ( m )} )}^{- 1}}^{2} + tr ( {( {Γ}_{pr}^{k , ( m )} )}^{- 1} {Γ}_{p o s t}^{k , ( m )} ) + {‖ {μ}_{p o s t}^{k , ( m )} - {μ}_{pr}^{k , ( m )} ‖}_{{( {Γ}_{p r}^{k , ( m )} )}^{- 1}}^{2} - log \vert {Γ}_{p o s t}^{k , ( m )} \vert$$
$$where ( {μ}_{p o s t}^{k , ( m )} , {( {Γ}_{p o s t}^{k , ( m )} )}^{\frac{1}{2}} ) = Ψ ( {y}^{n , ( m )} , W ) ,$$
$${u}_{draw}^{k , ( m ) , p} ( W ) ∼ 𝒩 ( {μ}_{p o s t}^{k , ( m )} , {Γ}_{p o s t}^{k , ( m )} )$$

3. The method of claim 1, wherein the neural network is a recurrent neural network.

4. The method of claim 1, further comprising:
inputting an observed sequence of data into the trained neural network to obtain statistics of a posterior model.

5. The method of claim 1, wherein the statistics of a posterior model include mean and covariance of a Gaussian distribution.

6. The method of claim 1, where the identified evolution model utilizes a log-spectral amplitude expressed as:
$${k}_{*}^{} = {\underbrace{{g}_{MMSE , k} {e}^{\frac{1}{2} {\int }_{{ν}_{k}}^{∞} \frac{{e}^{- t}}{t} dt}}}_{{g}_{LSA} ( k )} {k}_{}$$
where g_{MMSE,k} represents PoI.

7. The method of claim 1, where the identified evolution model utilizes an optimally modified log-spectral amplitude expressed as:
$${k}_{*}^{} = {\underbrace{{g}_{min}^{1 - {p}_{k}} {g}_{LSA , k}^{{p}_{k}}}}_{{g}_{OMLSA} ( k )} {k}_{} .$$

8. The method of claim 1, further comprising:
inputting a noisy signal short-time spectral amplitude (STSA) to the neural network; and
obtaining as output an estimate of minimum mean squared estimate spectral gain.

9. The method of claim 1, where the noise model is expressed as \tilde{y}ₜ˜ [symbol] (ηxₜ, ηxₜ).

10. A method for estimating parameters of an evolution model, the method comprising:
identifying an evolution model;
obtaining a set of observed data values;
providing the set of observed data values as input to a neural network to obtain an estimate of parameter-of-interest of the evolution model as output, where the neural network is trained by:
obtaining a set of training data values, where each value in the set is associated with a PoI associated with the evolution model;
obtaining a noise model representing noise affecting the output of the evolution model;
obtaining a prior model that represents prior information on characteristics of the parameter-of-interest;
constructing a loss function for the neural network, where the loss function incorporates the set of training data values, the evolution model, the noise model, and the prior model; and
training the neural network with the loss function to obtain updated weights.

11. The method of claim 10, wherein the neural network further provides an uncertainty of the estimate as output.

12. The method of claim 1, where the loss function is
$${W}^{⋆} = arg {min}_{W} \frac{1}{M} {\sum }_{m = 1}^{M} \frac{1 - α}{α} ( log \vert {Γ}_{p o s t}^{k , ( m )} \vert + {‖ {μ}_{p o s t}^{k , ( m )} - {u}^{k , ( m )} ‖}_{{( {Γ}_{p o s t}^{k , ( m )} )}^{- 1}}^{2} ) + \frac{1}{p} {\sum }_{p = 1}^{p} {‖ {y}^{n , ( m )} - ℱ ( {u}_{draw}^{k , ( m ) , p} ( W ) , t ) - {μ}_{v}^{n , ( m )} ‖}_{{( {Γ}_{v}^{n , ( m )} )}^{- 1}}^{2} + tr ( {( {Γ}_{pr}^{k , ( m )} )}^{- 1} {Γ}_{p o s t}^{k , ( m )} ) + {‖ {μ}_{p o s t}^{k , ( m )} - {μ}_{pr}^{k , ( m )} ‖}_{{( {Γ}_{p r}^{k , ( m )} )}^{- 1}}^{2} - log \vert {Γ}_{p o s t}^{k , ( m )} \vert$$
$$where ( {μ}_{p o s t}^{k , ( m )} , {( {Γ}_{p o s t}^{k , ( m )} )}^{\frac{1}{2}} ) = Ψ ( {y}^{n , ( m )} , W ) ,$$
$${u}_{draw}^{k , ( m ) , p} ( W ) ∼ 𝒩 ( {μ}_{p o s t}^{k , ( m )} , {Γ}_{p o s t}^{k , ( m )} )$$

13. The method of claim 1, wherein the neural network is a recurrent neural network.

14. The method of claim 1, wherein the statistics of a posterior model include mean and covariance of a Gaussian distribution.

15. The method of claim 1, where the identified evolution model utilizes a log-spectral amplitude expressed as:
$${k}_{*}^{} = {\underbrace{{g}_{MMSE , k} {e}^{\frac{1}{2} {\int }_{{ν}_{k}}^{∞} \frac{{e}^{- t}}{t} dt}}}_{{g}_{LSA} ( k )} {k}_{}$$
where g_{MMSE,k} represents PoI.

16. The method of claim 1, where the identified evolution model utilizes an optimally modified log-spectral amplitude expressed as:
$${k}_{*}^{} = {\underbrace{{g}_{min}^{1 - {p}_{k}} {g}_{LSA , k}^{{p}_{k}}}}_{{g}_{OMLSA} ( k )} {k}_{} .$$

17. The method of claim 1, further comprising:
inputting a noisy signal short-time spectral amplitude (STSA) to the neural network; and
obtaining as output an estimate of minimum mean squared estimate spectral gain.

18. The method of claim 1, where the noise model is expressed as \tilde{y}ₜ˜ [symbol] (ηxₜ, ηxₜ).

19. An estimation device executing a neural network for estimating parameters of an evolution model, comprising:
a processor;
a memory comprising estimation instructions and a neural network;
where the estimation instructions when executed direct the processor to:
identify an evolution model;
obtain a set of training data values, where each value in the set is associated with a parameter-of-interest (PoI) associated with the evolution model;
obtain a noise model representing noise affecting the output of the evolution model;
obtain a prior model that represents prior information on characteristics of the parameter-of-interest;
construct a loss function for the neural network, where the loss function incorporates the set of training data values, the evolution model, the noise model, and the prior model; and
train the neural network with the loss function to obtain updated weights.

20. The estimation device of claim 19, where the loss function is
$${W}^{⋆} = arg {min}_{W} \frac{1}{M} {\sum }_{m = 1}^{M} \frac{1 - α}{α} ( log \vert {Γ}_{p o s t}^{k , ( m )} \vert + {‖ {μ}_{p o s t}^{k , ( m )} - {u}^{k , ( m )} ‖}_{{( {Γ}_{p o s t}^{k , ( m )} )}^{- 1}}^{2} ) + \frac{1}{p} {\sum }_{p = 1}^{p} {‖ {y}^{n , ( m )} - ℱ ( {u}_{draw}^{k , ( m ) , p} ( W ) , t ) - {μ}_{v}^{n , ( m )} ‖}_{{( {Γ}_{v}^{n , ( m )} )}^{- 1}}^{2} + tr ( {( {Γ}_{pr}^{k , ( m )} )}^{- 1} {Γ}_{p o s t}^{k , ( m )} ) + {‖ {μ}_{p o s t}^{k , ( m )} - {μ}_{pr}^{k , ( m )} ‖}_{{( {Γ}_{p r}^{k , ( m )} )}^{- 1}}^{2} - log \vert {Γ}_{p o s t}^{k , ( m )} \vert$$
$$where ( {μ}_{p o s t}^{k , ( m )} , {( {Γ}_{p o s t}^{k , ( m )} )}^{\frac{1}{2}} ) = Ψ ( {y}^{n , ( m )} , W ) ,$$
$${u}_{draw}^{k , ( m ) , p} ( W ) ∼ 𝒩 ( {μ}_{p o s t}^{k , ( m )} , {Γ}_{p o s t}^{k , ( m )} )$$

21. The estimation device of claim 19, wherein the neural network is a recurrent neural network.

22. The estimation device of claim 19, the estimation instructions further comprising:
inputting an observed sequence of data into the trained neural network to obtain statistics of a posterior model.

23. The estimation device of claim 19, wherein the statistics of a posterior model include mean and covariance of a Gaussian distribution.

24. The estimation device of claim 19, where the identified evolution model utilizes a log-spectral amplitude expressed as:
$${k}_{*}^{} = {\underbrace{{g}_{MMSE , k} {e}^{\frac{1}{2} {\int }_{{ν}_{k}}^{∞} \frac{{e}^{- t}}{t} dt}}}_{{g}_{LSA} ( k )} {k}_{}$$
where g_{MMSE,k} represents PoI.

25. The estimation device of claim 19, where the identified evolution model utilizes an optimally modified log-spectral amplitude expressed as:
$${k}_{*}^{} = {\underbrace{{g}_{min}^{1 - {p}_{k}} {g}_{LSA , k}^{{p}_{k}}}}_{{g}_{OMLSA} ( k )} {k}_{} .$$

26. The estimation device of claim 19, the estimation instructions further comprising:
inputting a noisy signal short-time spectral amplitude (STSA) to the neural network; and
obtaining as output an estimate of minimum mean squared estimate spectral gain.

27. The estimation device of claim 19, where the noise model is expressed as \tilde{y}ₜ˜ [symbol] (ηxₜ, ηxₜ).
